(19) United States
(12) Patent Application Publication
(10) Pub. No.: US 2012/0060545 A1
(43) Pub. Date: Mar. 15, 2012

(54) CONDENSER ASSEMBLY FOR MULTIPLE REFRIGERATION SYSTEMS

(75) Inventors: Alexander P. Rafalovich, Sarasota, FL (US); Bryan William Snider, Louisville, KY (US); Yuriy Zell, Louisville, KY (US)

(73) Assignee: GENERAL ELECTRIC COMPANY, Schenectady, NY (US)

(21) Appl. No.: 12/958,474

(22) Filed: Dec. 2, 2010

(51) Int. Cl. F25D 17/06; F28F 13/12; B23P 15/26; F28F 1/10

(52) U.S. Cl. 62/455; 165/172; 165/104.34; 29/890.035

(57) ABSTRACT

A dual system refrigerator condenser assembly includes a first condenser tube member having a width and opposite connection ends, and a second condenser tube member having a width and opposite connection ends. The condenser tube members are disposed width-wise adjacent to each other and in a common plane. A plurality of wires are connected to and span the respective widths of the first and second condenser tube members. The first condenser tube member is connectable to a first sealed system and the second condenser tube member is connectable to a second sealed system within a refrigerator.

### FIELD OF THE INVENTION

The present subject matter relates generally to refrigeration systems, and more particularly to condensers for such systems.

### BACKGROUND OF THE INVENTION

Refrigeration systems typically include a compressor coupled to a condenser so that a compressed vapor refrigerant flows to the condenser. A condenser fan circulates air over a surface of the condenser to cool the compressed refrigerant. Condenser surfaces for refrigerators are typically of tube and wire construction in which a refrigerant tube, or condenser coil, includes a plurality of U-shaped segments and is attached to a plurality of substantially parallel wires. In one type of known condenser system, a plurality of tube and wire members are placed in parallel rows underneath a refrigerator cabinet in an air flow path extending from a front of the refrigerator cabinet (see, for example, U.S. Pat. No. 5,592,829). However, this requires an increased distance between the refrigerator cabinet and a floor to provide adequate air access to the condenser surfaces, and, more importantly, suffers from reduced efficiency due to unevenly distributed airflow across the condenser surfaces and airflow parallel to the refrigerant tubes and/or wires. Air flowing through a relatively small air path through a lower front of the refrigerator produces relatively high air velocity and pressure drop of the air, which reduces an airflow rate across the condenser, increases noise, and reduces condenser efficiency.

Efforts have been made to reduce the condenser volume or space in the refrigerator machinery compartment. For example, U.S. Pat. No. 5,685,166 proposes rectangular or cube shaped condensers to minimize condenser volume. However, these condensers also suffer efficiency losses due to uneven airflow over the condenser surfaces and airflow parallel to the condenser surfaces. Thus, extra coil surface area is often required to achieve a desired heat transfer to the air. Also, a considerable number of U-shaped elbows with small radiuses are required to fabricate the rectangular condenser shape, which increases condenser cost and decreases condenser reliability.

U.S. Pat. No. 7,121,328 proposes a tube-and-wire condenser spiraled about a longitudinal axis to address certain efficiency and space considerations.

Condenser considerations are compounded for refrigerators having separate sealed systems. For example, larger refrigerators having separately controlled freezer compartments often utilize a separate sealed refrigeration system for each compartment, which requires separate condensers and their respective space and efficiency issues.

Accordingly, it would be desirable to provide an efficient refrigerator condenser that also addresses the space concerns of multiple condensers in dual sealed systems.

### BRIEF DESCRIPTION OF THE INVENTION

Aspects and advantages of the invention will be set forth in part in the following description, or may be obvious from the description, or may be learned through practice of the invention.

In an exemplary embodiment, a dual system refrigerator condenser assembly is provided. The system includes a first condenser tube member having a width and opposite connection ends, and a second condenser tube member having a width and opposite connection ends. The condenser tube members may, in a particular embodiment, include a plurality of U-shaped members. The first and second condenser tube members disposed width-wise adjacent to each other and in a common plane. A plurality of common wires are connected to and span across the widths of the condenser tube members. For installation in a refrigerator having duel sealed refrigeration systems, the assembly is common to both systems with the connection ends of the first condenser tube member connectable to the first sealed system and the connection ends of the second condenser tube member connectable to the second sealed system.

In still a further embodiment, the present invention encompasses a refrigerator having a first sealed refrigeration system and a second sealed refrigeration system. A common condenser assembly is configured between the first and second sealed refrigeration systems. The condenser assembly includes a first condenser tube member having a width and opposite connection ends, and a second condenser tube member having a width and opposite connection ends. The first and second condenser tube members are disposed width-wise adjacent to each other in a common plane. A plurality of wires are connected to and span the widths of the first and second condenser tube members (the wires are common to both tube members). The first condenser tube member is connected to the first sealed refrigeration system and the second condenser tube member is connected to the second sealed refrigeration system within the refrigerator.

The present invention also encompasses various method embodiments for forming a dual system refrigerator condenser assembly that may also be used in a single sealed system refrigerator. The method includes disposing a first condenser tube member having a width and opposite connection ends in a common plane and width-wise adjacent to a second condenser tube member having a width and opposite connection ends. The adjacent connection ends of the first and second condenser tube members are interconnected with a tubular bridge member, which may be a U-shaped tube. A plurality of wires are attached across the respective widths of the interconnected first and second condenser tube members, for example in a conventional welding process. The interconnected first and second condenser tube members and connected wires are formed into a final configuration with the bridge member attached. For installation into a dual system refrigerator, the bridge member can be removed so that the connection ends of the first condenser tube member may be attached to one system, and the connection ends of the second condenser tube member may be attached to the other system. For installation into a single system refrigerator, the bridge member may be left as a permanent link between the condenser tube members such that the connected members essentially define a single continuous condenser tube member that can be connected into the single system.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an exemplary refrigerator that may incorporate aspects of the invention;

FIG. 2 is a rear schematic view of the refrigerator of FIG. 1 illustrating multiple sealed cooling systems and condenser assembly;

FIG. 3 is a view of a partially formed condenser tube assembly having multiple condenser tubes;

FIG. 4 is a view of the completed condenser tube assembly of FIG. 3 is flat, planar form; and

FIG. 5 is a perspective view of the condenser tube assembly of FIG. 4 formed into a spiral configuration.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

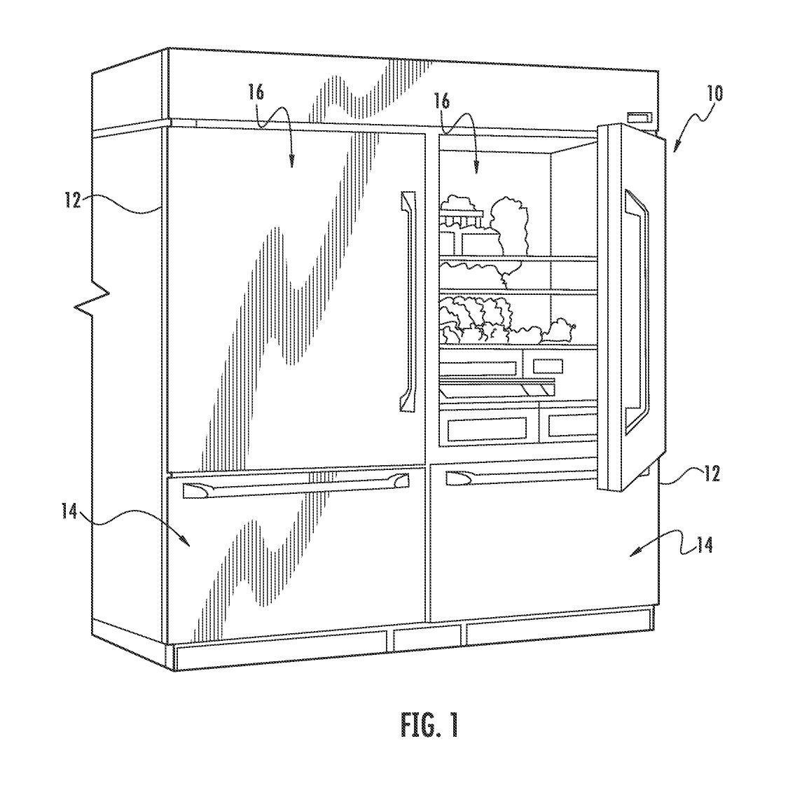

FIG. 1 depicts a refrigerator 10 having a casing 12 that defines separately controlled freezer compartments 14 (and associated fresh food compartments 16). It should be appreciated that the term “refrigerator” is used in a generic sense herein to encompass any manner of refrigeration appliance, such as a freezer, refrigerator/freezer combination, and any style or model of conventional refrigerator that may take advantage of the condenser assembly described herein. The particular style of refrigerator depicted in FIG. 1 is for illustrative purposes only. Conventional dual system refrigerators of the type depicted in FIG. 1 would typically include separate sealed refrigeration systems for each respective freezer compartment 14, with each system having its own condenser.

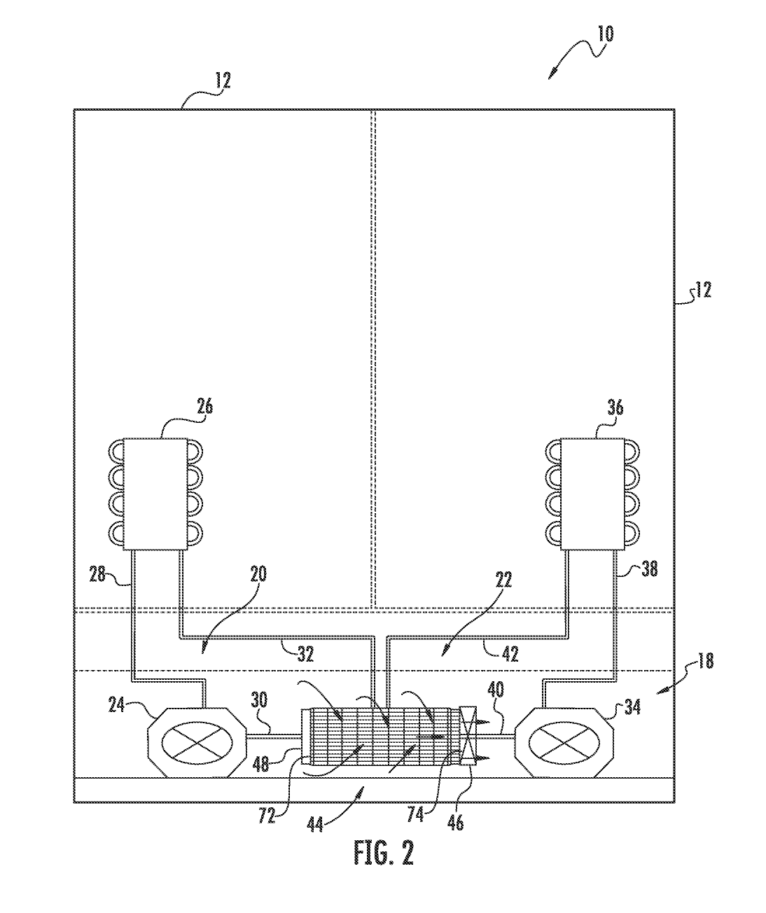

As mentioned, the refrigerator 10 of FIG. 1 has separately controlled freezer compartments 14 and, thus, includes separate sealed refrigeration systems. These separate sealed refrigeration systems 20, 22 are depicted in the schematic view of FIG. 2. The refrigerator 10 includes a machinery compartment 18 that contains components of the sealed refrigeration systems 20, 22, including a condenser assembly 44 in accordance with aspects of the invention and described in greater detail below. Still referring to FIG. 2, the first sealed refrigeration system 20 includes a compressor 24, evaporator 26, and is operationally configured with the condenser assembly 44. The compressor 24, evaporator 26, and condenser assembly 44 are connected in series, and the system is charged with a refrigerant. The evaporator 26 is a type of heat exchanger that transfers heat from air passing over the evaporator to the refrigerant flowing through the evaporator coils, thereby causing the refrigerant to vaporize. As such, cooled air is produced and configured to refrigerate the respective compartments 12, 14. The first sealed system 20 includes a suction tube 28 connected between the compressor 24 and evaporator 26, a capillary tube 32 connected between the evaporator 26 and the condenser assembly 44, and an inlet tube connected between the condenser assembly 44 and the compressor 24, as it is commonly understood in the art.

The second sealed refrigeration system 22 is similarly configured, and includes evaporator 36, compressor 34, and condenser assembly 44. The suction tube 38 is connected between the evaporator 36 and compressor 34, and an inlet tube 40 is connected between the condenser assembly 44 and the compressor 34. A capillary tube 42 is connected between the evaporator 36 and the condenser assembly 44.

The configuration and operation of sealed refrigeration systems 20, 22 is well known to those skilled in the art and a detailed explanation of the components and operation of the systems is not necessary for purposes of the present description.

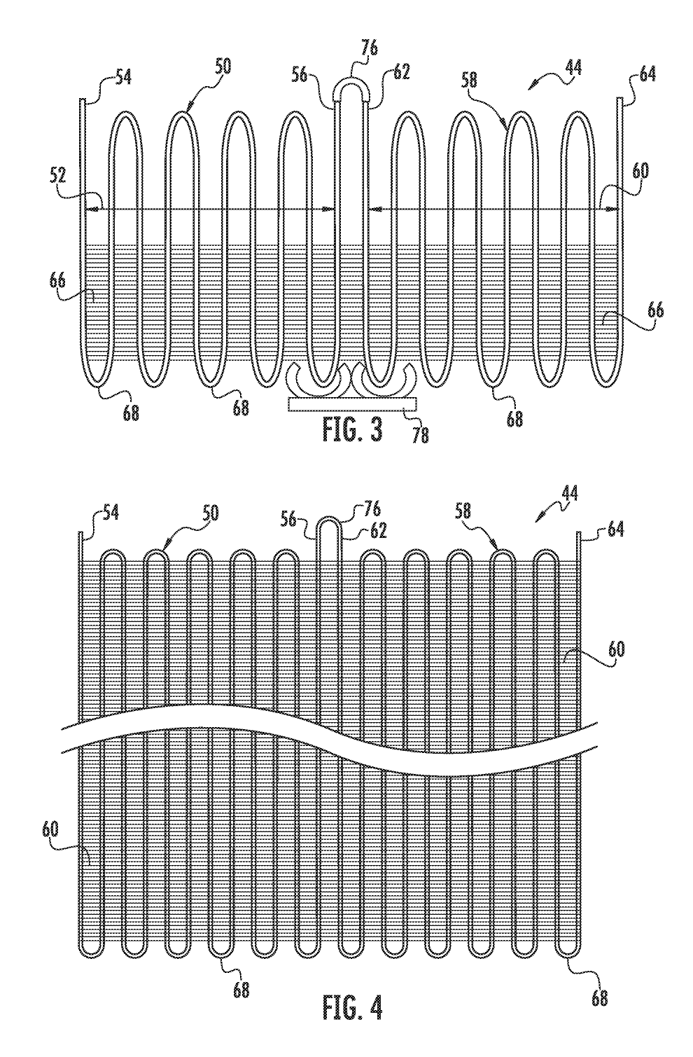

Referring to FIGS. 2 through 5 in particular, the condenser assembly 44 is uniquely configured to be a common component of the dual refrigeration systems 20, 22. Condenser assembly 44 includes a first condenser tube member 50 having a width 52 and opposite connection ends 54, 56. The condenser assembly 44 includes a second condenser tube member 58 having a width 60 and opposite connection ends 62, 64, as particularly depicted in FIG. 3. The first and second condenser tube members 50, 58 are disposed adjacent to each other (width-wise) and in a common plane such that the connection end 56 of the first condenser tube member 50 is adjacent to the connection end 62 of the second condenser tube member 58. A plurality of common wires 66 span the width of the first and second condenser tube members 50, 58 and are welded across the condenser tube members 50, 58 in a known conventional welding process.

Each of the first and second condenser tube members 50, 58 are formed of an extended refrigerant tube that is shaped into a plurality of U-shaped segments 68. The segments 68 extend substantially perpendicular to the common wires 66. The number of U-shaped segments 68 is selected to achieve a desired heat transfer rate to air flowing over the surface of the tubes (and wires 66) without an excessive pressure drop in the refrigerant flowing through the tubes. It should be appreciated that other known configurations of tube and wire members could be used in alternative embodiments of the condenser assembly 44 within the scope and spirit of the invention.

Referring to FIG. 2, upon configuration of the condenser assembly 44 in a dual refrigerant system, the first condenser tube member 50 is connectable to the first sealed system 20 via the connection ends 54, 56, and the second condenser tube member 58 is connected to the second sealed system 22 via the connection ends 62 and 64.

The first and second condenser tube members 50, 58 (and attached common wires 66) may be formed into any manner of three-dimensional shape, including the spiral tube configuration 70 depicted in FIG. 5. Other three-dimensional shapes are also possible, including a V-shape, box-shape, and so forth. The spiral configuration 70 in FIG. 5 has opposite ends 72, 74 and a longitudinal axis that is essentially perpendicular to the plane of the sides 72, 74. When installed into the dual systems 20, 22 of the refrigerator 10 in FIG. 2, the condenser assembly 44 may be oriented longitudinally within the machinery compartment 18 between the compressors 24, 34. The inlet tube 30 and capillary line 32 of the first sealed system 20 are connected to the respective connection ends 54, 56 of the first condenser tube member 50. Likewise, the inlet tube 40 and capillary line 42 of the second seal system 22 are connected to the connection ends 62, 64 of the second condenser tube member 58. A condenser fan 46 is disposed in the machinery compartment 18 at either one of the ends 72, 74. At the opposite end 74, 72, a closure member 48, such as any manner of plate or baffle, is disposed across the open end 72 so as to inhibit axial air flow through the spiral tube configuration 70. The fan 46 draws air through the circumference of the spiral tube configuration 70 substantially transverse to the longitudinal axis of the condenser assembly 44, as indicated by the arrows in FIG. 2. This unique configuration enhances efficiency of heat transfer through the condenser assembly 44.

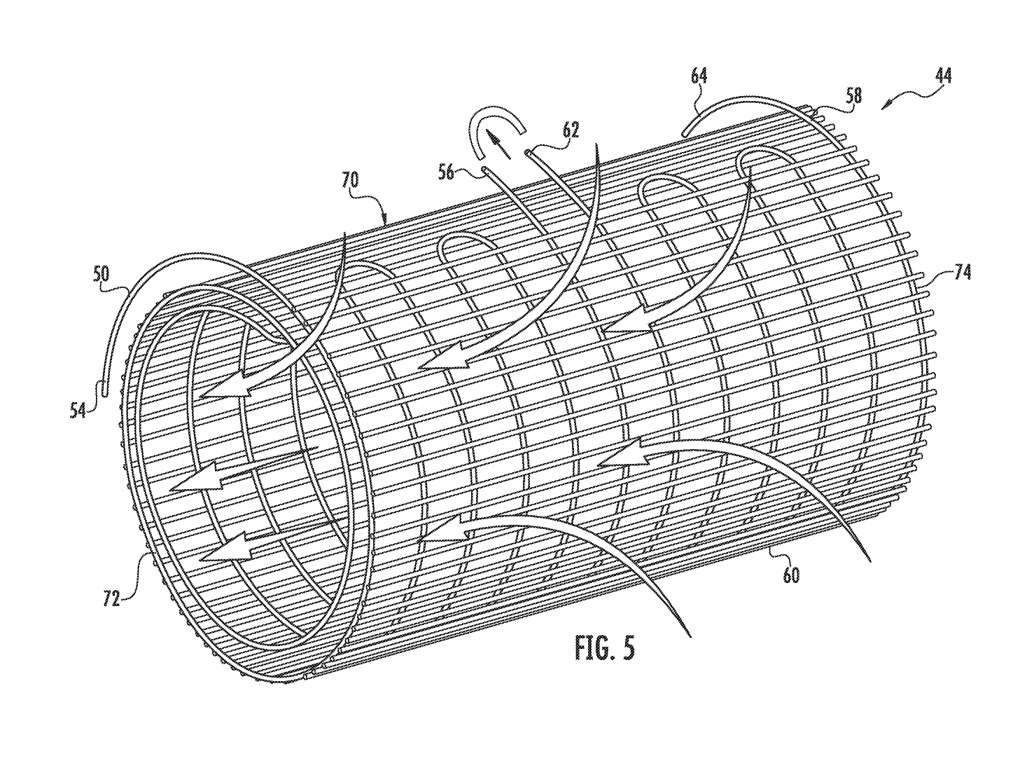

FIGS. 3 and 4 depict a tubular bridge member 76 that may be used to interconnect adjacent connection ends 56, 62 of the respective condenser tube members 50, 58. This bridge member 76 is used during formation and various processing steps for manufacture of the integral condenser tube assembly 44. The bridge member 76 serves to support the tube members during the various bending, painting, and soldering processes, as well as protecting the connection ends and minimizing the amount of surface preparation of the ends for subsequent installation of the condenser tube assembly into the sealed systems 20, 22. As depicted in FIG. 5, the bridge member 76 may be removed from the connection ends 56, 62 at the time of installation of the condenser assembly 44 into the refrigerator 10.

FIG. 3 also depicts a clip member 78 that may be used in conjunction with the bridge member 76 to further support adjacent segments 68 of the respective condenser tube members 50, 58 during any portion of the manufacturing process.

In a unique configuration, the condenser assembly 44 may also serve as a single condenser in a single sealed refrigeration system by leaving the tubular bridge member 76 connected between the adjacent condenser tube members 50, 58. In other words, the bridge member 76 interconnects the two condenser tube members so as to form a single continuous condenser tube member that may be connected into a single sealed refrigeration system via the connection ends 54 and 64. This unique aspect of the condenser assembly 44 may be particularly desirable in that the same condenser assembly 44 may be used in different types of refrigerators, including single and dual sealed system refrigerators. This unique aspect has obvious manufacturing and logistical benefits.

It should be readily appreciated that the present invention also encompasses any manner of refrigerator 10 (FIGS. 1 and 2) that utilizes the unique condenser assembly described herein.

It should also be readily appreciated that the present invention encompasses various method embodiments for forming a refrigerator condenser assembly that may be used in a single or dual sealed system refrigerator. For example, a particular method embodiment includes disposing a first condenser tube member 50 having a width 52 and opposite connection ends 54, 56 in a common plane and adjacent to a second condenser tube member 58 having a width 60 and opposite connection ends 62, 64. The adjacent connection ends of the first and second condenser tube members 50, 58 are interconnected with a tubular bridge member 76, which may be, for example, a U-shaped tube. A plurality of wires 60 are attached across the respective widths of the interconnected first and second condenser tube members 50, 58, for example in a conventional welding process. The interconnected first and second condenser tube members 50, 58 and connected wires 60 are then formed into a final configuration, for example a spiral configuration 70, with the bridge member 76 attached. For installation into a dual system refrigerator, the bridge member 76 is removed so that the connection ends of the first condenser tube member 50 may be attached to one system, and the connection ends 62, 64 of the second condenser tube member 58 may be attached to the other refrigeration system. For installation into a single system refrigerator, the bridge member 76 is left as a permanent link between the adjacent condenser tube members 50, 58 so that the connected members essentially define a single continuous condenser tube member that is connected into the single refrigeration system.

Various other method steps as described above are also encompassed in various method embodiments in accordance with aspects of the invention.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dual system refrigerator condenser assembly, comprising:
a first condenser tube member having a width and opposite connection ends;
a second condenser tube member having a width and opposite connection ends;
said first and second condenser tube members disposed width-wise adjacent to each other and in a common plane; and
a plurality of common wires connected to and spanning said widths of said first and second condenser tube members;
wherein said first condenser tube member is connectable to a first sealed system and said second condenser tube member is connectable to a second sealed system within a refrigerator.

2. The condenser assembly as in claim 1, wherein said first and second condenser tube members comprise a plurality of U-shaped segments between said opposite connection ends, said wires substantially parallel to each other and attached across said U-shaped segments.

3. The condenser assembly as in claim 2, wherein said first and second condenser tube members and attached wires are wound into a spiraled tube configuration having a longitudinal axis and first and second ends.

4. The condenser assembly as in claim 3, further comprising a condenser fan disposed at said first end and a closure member disposed at said second so as to inhibit axial airflow through said spiraled tube configuration, said fan drawing air through said circumference of said spiraled tube configuration substantially transverse to said longitudinal axis.

5. The condenser assembly as in claim 1, further comprising a tubular bridge member configured for connection between adjacent said connection ends of said first and second condenser tube members, wherein said condenser assembly converts to a single sealed system condenser upon connection of said tubular bridge member.

6. A refrigerator, comprising:
a first sealed refrigeration system, and a second sealed refrigeration system;
a common condenser assembly configured with each of said first and second sealed refrigeration systems, said condenser assembly further comprising:
a first condenser tube member having a width and opposite connection ends;
a second condenser tube member having a width and opposite connection ends;
said first and second condenser tube members disposed width-wise adjacent to each other and in a common plane; and
a plurality of common wires connected to and spanning said widths of said first and second condenser tube members;
wherein said first condenser tube member is connected to said first sealed refrigeration system and said second condenser tube member is connected to said second sealed refrigeration system.

7. The refrigerator as in claim 6, wherein said first and second condenser tube members comprise a plurality of U-shaped segments between said opposite connection ends, said wires substantially parallel to each other and attached across said U-shaped segments.

8. The refrigerator as in claim 7, wherein said first and second condenser tube members and attached wires are wound into a spiraled tube configuration having a longitudinal axis and first and second ends, said spiraled tube configuration disposed between said first and second sealed refrigeration systems.

9. The refrigerator as in claim 8, further comprising a condenser fan disposed at said first end and a closure member disposed at said second of said spiraled tube configuration so as to inhibit axial airflow through said spiraled tube configuration, said fan drawing air through said circumference of said spiraled tube configuration substantially transverse to said longitudinal axis.

10. A method for forming a dual system refrigerator condenser assembly, comprising:
disposing a first condenser tube member having a width and opposite connection ends in a common plane and width-wise adjacent to a second condenser tube member having a width and opposite connection ends;
interconnecting adjacent connection ends of the first and second condenser tube members with a tubular bridge member;
attaching a plurality of wires across the widths of the interconnected first and second condenser tube members; and
forming the interconnected first and second condenser tube members into a final configuration with the bridge member attached.

11. The method as in claim 10, further comprising installing the final configuration into a refrigerator having dual sealed refrigeration systems, removing the bridge member, and connecting the connection ends of the first condenser tube member to a first sealed refrigeration system and connecting the connection ends of the second condenser tube member to a second sealed refrigeration system.

12. The method as in claim 10, wherein the first and second condenser tube members include a plurality of U-shaped segments between the respective opposite connection ends, and connecting the wires substantially parallel to each other and attached across the U-shaped segments.

13. The method as in claim 12, further comprising winding the first and second condenser tube members and attached wires into a final spiraled tube configuration having a longitudinal axis and first and second ends.

14. The method as in claim 13, further comprising installing the spiraled tube configuration into a refrigerator having dual sealed refrigeration systems, removing the bridge member, and connecting the connection ends of the first condenser tube member to a first sealed refrigeration system and connecting the connection ends of the second condenser tube member to a second sealed refrigeration system.

15. The method as in claim 14, further comprising essentially closing off the first end of the spiraled tube configuration to airflow and drawing air through the circumferential surface of the spiraled tube configuration with a condenser fan disposed at the second end of the spiraled tube configuration.

16. The method as in claim 12, further comprising supporting the first and second condenser tube members with at least one removable clip attached between adjacent U-shaped sections during attachment of the wires across the first and second condenser tube members.

17. The method as in claim 10, further comprising leaving the bridge member connected between the first and second condenser tube members and installing the final configuration into a refrigerator having a single sealed refrigeration system.
